(19) United States
(12) Patent Application Publication
(10) Pub. No.: US 2009/0175994 A1
(43) Pub. Date: Jul. 9, 2009

(54) Toasting Apparatus and Method

(76) Inventors: Paul Wing Sun Chung, Hong Kong (HK); Brian Sun, Hong Kong (HK)

Correspondence Address: EAGLE IP LIMITED, 22/F., KWAI HUNG HOLDINGS CENTRE, 89 KING'S ROAD, NORTH POINT, HK

(21) Appl. No.: 11/971,890

(22) Filed: Jan. 9, 2008

(51) Int. Cl. A47J 37/08; A21B 1/42

(52) U.S. Cl. 426/466; 99/386; 99/443 C; 219/388

(57) ABSTRACT

An apparatus and method for toasting a piece of bread are disclosed. The apparatus includes a base to support the piece of bread so that the bread can rest thereon. Some heating elements are placed near to the two faces of the bread such that when the bread is conveyed in a horizontal direction while it is kept in a vertical position, the two faces of the bread can be uniformly heated.

### FIELD OF INVENTION

This present invention relates in general to ovens and more specifically to conveying toaster ovens.

### BACKGROUND OF INVENTION

In general there are two main types of electrical toasters: a vertical toaster and a flat bed toaster. In principle, the vertical toaster functions by placing a piece of bread on a vertical displaceable carrier, which is arranged in a slot between two side panels, each provided with heating elements. Hence, the vertical displaceable bread carrier is brought into the toaster to position the bread between the side panels. After the bread is toasted, the carrier can be released automatically or manually and the toasted bread is brought up and is ready to serve.

In principle, the flat bed toaster functions by placing bread flat on a horizontal surface. One side of the bread is toasted by heating elements positioned adjacent the bread.

### SUMMARY OF INVENTION

In the light of the foregoing background, it is an object of the present invention to provide an alternative apparatus and method for toasting.

Accordingly, the present invention, in one aspect, is an oven which includes a housing with an inlet opening, at least one heating element, and a transfer mechanism. The housing includes a base and two opposing side walls defining an interspace therebetween. The inlet opening is vertically disposed between the two opposing side walls on one side of the interspace. The heating elements are disposed on the interior of the side walls facing the interspace. The transfer mechanism is provided within the housing for transporting food product across the interspace from the inlet opening.

According to another aspect of the present invention, a method of toasting a piece of bread, the piece of bread having two faces and four sides, includes:

providing the piece of bread in a vertical position with at least one side of the piece of bread being juxtaposing to a vertically disposed heating element, the heating element being provided along the height of the piece of broad;

transferring the piece of bread in a horizontal direction along the longitude axis of the piece of bread with one side of the bread resting on to expose the entire surface of the two faces to the heating element using a transfer mechanism;

directly heating the piece of bread along the height thereof in the absence of blockage from the transfer mechanism; and

transferring the piece of bread against the heating element such that the piece of bread is being heated continuously in a direction against the moving direction of the piece of bread.

Using the present invention, the space occupied by the oven is reduced by keeping the vertical position of the toast during toasting, since the area of the base of the oven can be equal to or larger than one side of a piece of toast. Also, the oven described in the present invention automatically transports the toast with a reliable transport mechanism and combines advantages of both a vertical toaster and a flat bed toaster. People will be attracted by the operation of the oven as it is automatic and the whole process of transporting and gradually heating the toast from one end to another end are visible to the user.

Certain embodiments of the present invention are also able to achieve uniformly heating achieved as the heating elements may be placed next to the two faces of the toast, while the toast is actually supported by the base to avoid blockage. The transport mechanism makes the toast moving in a horizontal direction where the heating elements heat the whole face of toast equally from one end to another. As the toast is always kept in a vertical position, the two faces of the toast are equally heated without the interference of any supporting structures.

### BRIEF DESCRIPTION OF FIGURES

FIGS. 1a and 1b are the perspective view of an oven in one embodiment of the invention with a toast inserted in FIG. 1b for ease of illustration.

FIG. 2 is a perspective view of an oven with reduced length in another embodiment.

FIGS. 3a to 3d are a perspective view, top view, side view and front view of the oven with reduced length.

FIG. 4a shows an oven with extended base in another embodiment of the invention.

FIGS. 4b to 4d are an illustration on how toast is toasted using an oven with extended base.

FIGS. 5a to 5c show an oven with two holding channels in another embodiment of the invention.

FIGS. 6a to 6c show yet another oven with one side channel in another embodiment of the invention.

### DETAILED DESCRIPTION OF THE PREFERRED EMBODIMENTS

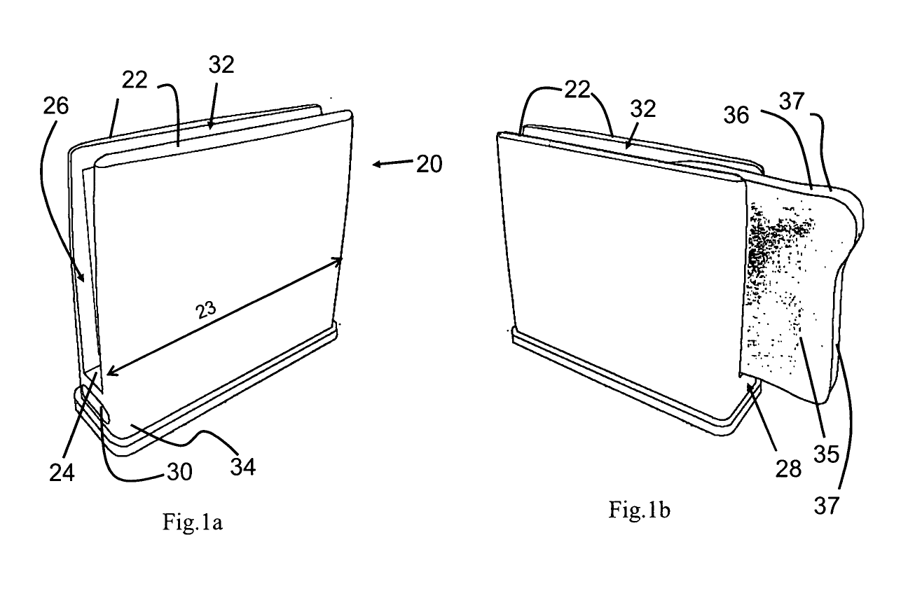

As used herein and in the claims, the “face” of a piece of bread or toast refers to the cutting face 35 of the bread. The “sides” or “side” of the bread refers to the four rims 37 of the bread, as shown in FIG. 1b.

Referring now to FIGS. 1a and 1b, the first embodiment of the present invention is an oven 20 for toasting a piece of bread 36, or a toast. The oven includes two side walls 22, a base 24, a inlet opening 26, an outlet opening 28, a hub 34, and a power control 30. The two sides walls 22 and the base 24 enclose an interspace 32 therebetween, and the side walls 22 and base 24 have their lengths 23 equal to or greater than that of a piece of toast 36. Inside the interspace there are one or more heating elements (not shown) installed in the side walls to provide heat to the bread 36 when it is introduced into the interspace, and the heating elements are adjacent to at least one face of the bread. There is also a transfer mechanism built inside the oven 20 to laterally move the bread while the bread is in an upright, vertical position.

In operation, the user inserts the bread 36 into the inlet opening 26 and the bread 36 begins moving forward by the transfer mechanism, while the heating elements provide heating to the bread 36. Since the heating elements are designed to have an equal or greater height than that of the bread 36, the bread 36, along its height, is uniformly heated. Further, as the bread 36 moves through the oven, the bread is supported vertically by the base 24, and uniform heating to every part of the bread 36 is achieved.

In one specific embodiment, there are also two horizontally aligned pulleys (not shown) disposed inside the hub 34. Drive cogs (not shown) connect vertically to each of said pulleys, and idler cogs (not shown) are disposed vertically within said interspace 32 and opposite to each said drive cog. One or more springs (not shown) are attached to one of the side walls 22 with one end and the other end attaching to the idler cogs. One of the pulleys is affixed to a motor located in the hub 34, where all the components in the transport mechanism are driven by the motor, either directly or indirectly. There is a belt (not shown) connecting the pulleys to make them rotate simultaneously with the same rotating speed. The heating elements are preferably made in the form of rods, but they can also be made in other forms such as heating plates or U-shaped coils. The heating element has a length equal to or greater than the height of the toast so that the toast can be equally heated along its height. Preferably, there are alumina hot plates located beside the heating elements and opposite to each other.

Now turning to the operation of the device described in the specific embodiment above. When the power control 30 is switched on by the user, the oven turns to operating status, and the heating elements and the motor are powered on. The power control 30 can also be used to adjust the power level of the oven depending on the user's preference on the dryness of the toasted bread. When the oven is powered on, the pulley affixed to the motor, which is called the drive pulley, and the other pulley, which is called the idler pulley, rotate with the same speed with the aid of a rubber band connecting them. Consequently, the drive cogs affixed to the pulleys are also rotating, and all the components that are rotating have the same rotating speed.

The user can then insert a piece of bread 36 vertically into the inlet opening 26. When one end of the bread 36 touches a pair of drive cog and idler cog nearest to the inlet opening 26, the bread 36 at one face is cogged by the drive cog and consequently is driven forward to cross the interspace 32. The idler cog touching the other face of the bread 36 will also be motivated to rotate by the frictional force from the bread. The base 24 provides support to the bread 36 which can stand thereon, so there is no need to use any other displaceable carrier to hold the bread.

The springs installed between the side wall 22 and the idler cogs provide flexibility and enable the interspace to accommodate breads having different widths. The springs are normally in an uncompressed status when bread with a minimum width is allowed to be cogged by the drive cog and idler cog. When a thicker piece of bread 36, i.e. bread with larger width, is introduced into the oven, the springs deform to a biased or compressed state. In this state, the separation between the drive cog and idler cog will be increased to adapt to the width of the bread, but still the cogs can firmly cog the bread due to the biasing force from the springs. For a typical application, the width of the interspace 32 ranges from 1.2 cm to 3 cm, while the height of the interspace 32 ranges from 10 cm to 20 cm.

While the bread 36 is being moved through the oven by the function of the transport mechanism, the heating elements provide heating to the bread 36. Specifically, when the bread is moving through the interspace 32, the two hot plates installed near the two opposite side walls touch or close to touch the two faces of the bread 36, and pass by the faces with constant speed, as a result of the relative movement between the hot plates and the bread. The hot plates are used here as an ideal heat conductor to spread the heat, which is generated by the heating elements that are placed behind the hot plates, uniformly on the plates. Since the heating elements are designed to have an equal or greater height than that of the bread 36, the bread 36, along its height, could be uniformly heated. Further, as the hot plates pass by the bread 36 from one end to the other end, the hot plates will heat the two faces of the bread 36 with a uniform heating to every part of the bread 36.

While one piece of bread is being toasted in the oven, the user can continuously insert more pieces of bread, one after another into the oven for toasting, as the breads will be heated and transported one-by-one like a streamline operation.

In another embodiment, a dust cover is provided as an accessory of the oven. The cover is used to cover the side walls 22 and the interspace 32 therebetween to protect the oven from dust and dirt.

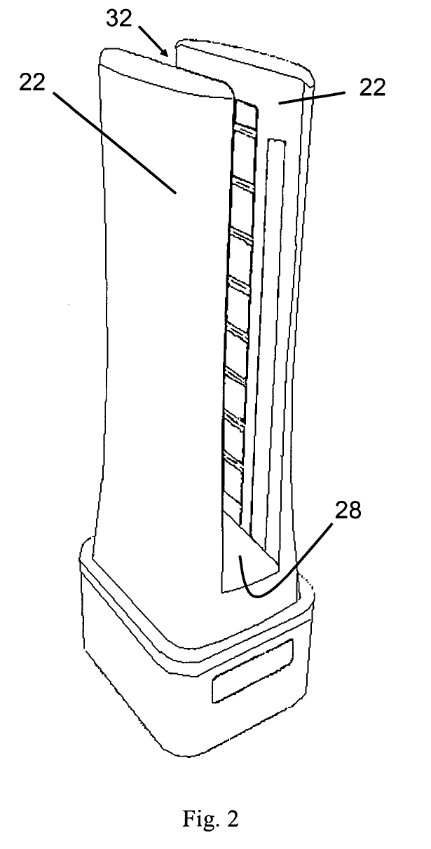

Turning to FIG. 2 now, in another embodiment, a slimmer embodiment of the oven is provided in which the length of the oven is reduced. In this configuration, the length of the oven is reduced to be less than the full length of a toast, i.e., the side walls 22 and resulting in the interspace 32 are narrower and do not cover the whole length of a piece of toast. This kind of slim design makes the oven easier to carry and store, takes up less space in a small kitchen and yet still allows uniform heating of the toast.

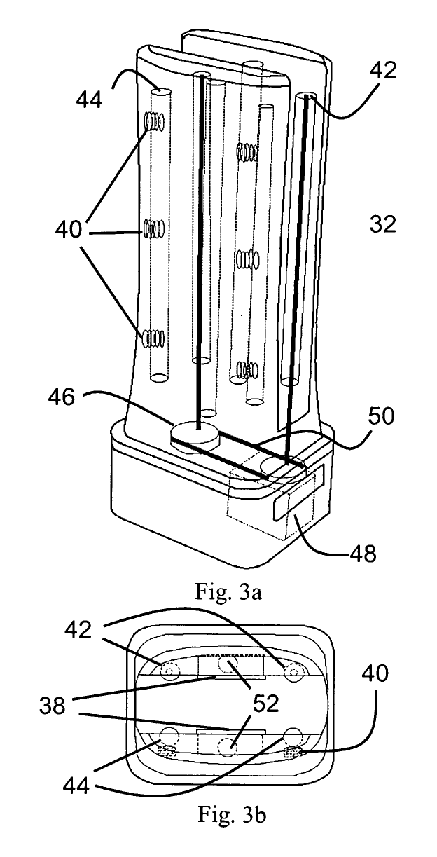

As shown in FIG. 3a to 3d, the internal components of the slim model oven, such as alumina hot plate 38, spring 40, drive cog 42, idler cog 44, pulley 46, motor 48, rubber band 50 and heating element 52, all have a similar configuration and structure to that of the previously described embodiments shown in FIGS. 1a and 1b. The working principle is also similar to the embodiment described above, except that the one side of the untoasted bread and/or part of the toasted bread can be seen to move across the toaster, adding to the visual enjoyment of the user.

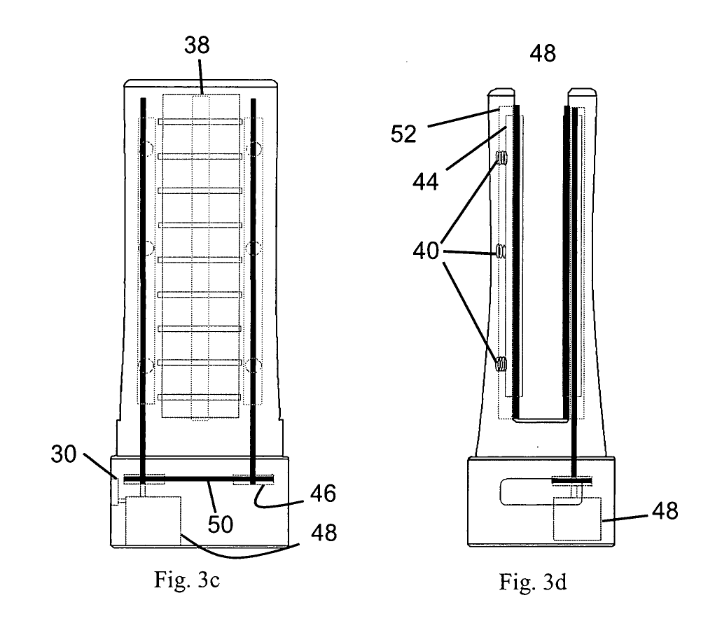

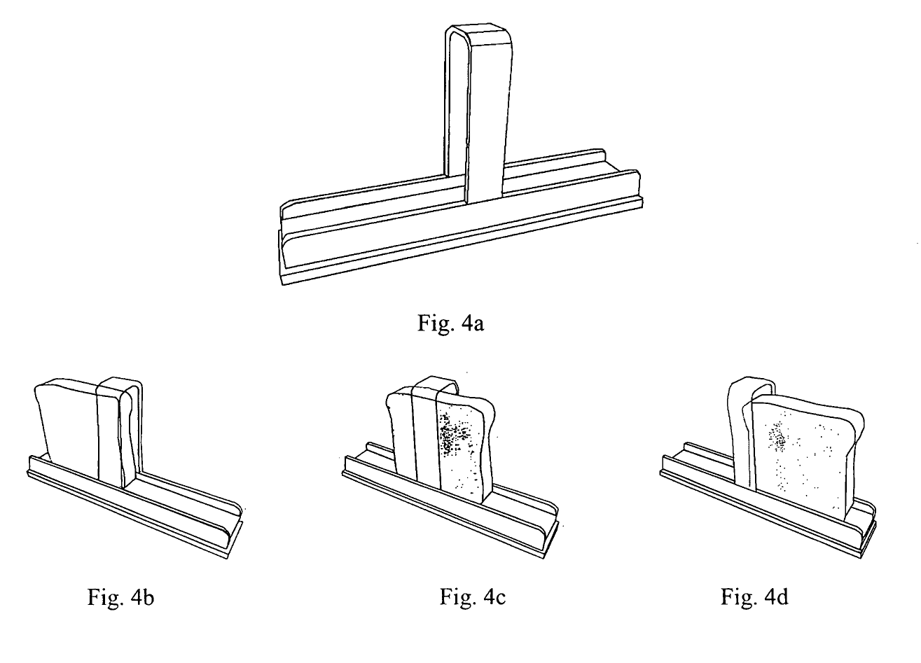

In another embodiment shown in FIGS. 4a to 4d, the two distal ends of the base of the oven are extended from the side walls, while the side walls are shown in the slim model. This configuration provides a sliding path for the bread so that the user can push the bread into the oven instead of holding and inserting the bread into the oven, as described in previous embodiments. All the other internal components, structures, and the oven's working principle, are similar to the embodiments described above, so the same reference numerals are assigned for ease of reference.

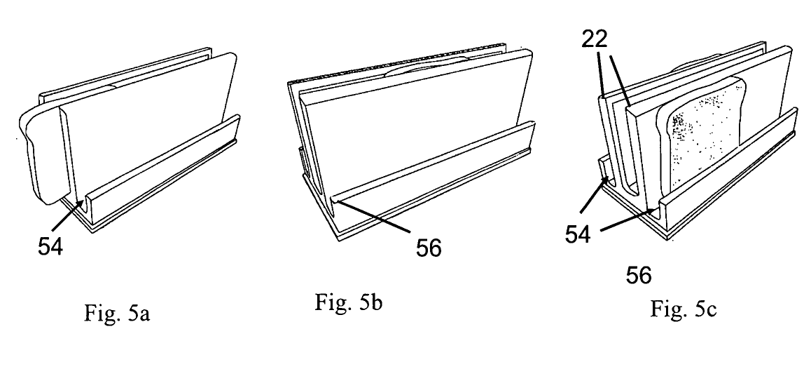

In another embodiment shown in FIGS. 5a to 5c, the base of the oven is further widened to include two grooves 54, which are provided along a longitudinal axis of an upper surface for supporting one or more pieces of toast in a vertical position. The grooves 54 are enclosed by a side wall 22 and a rail 56 which extends from the edge of the base. This allows additional pieces of toast, those either before toasting or after toasting, to be stored within such channels. All the other internal components, structures, and the oven's working principle, are similar to the embodiments described above.

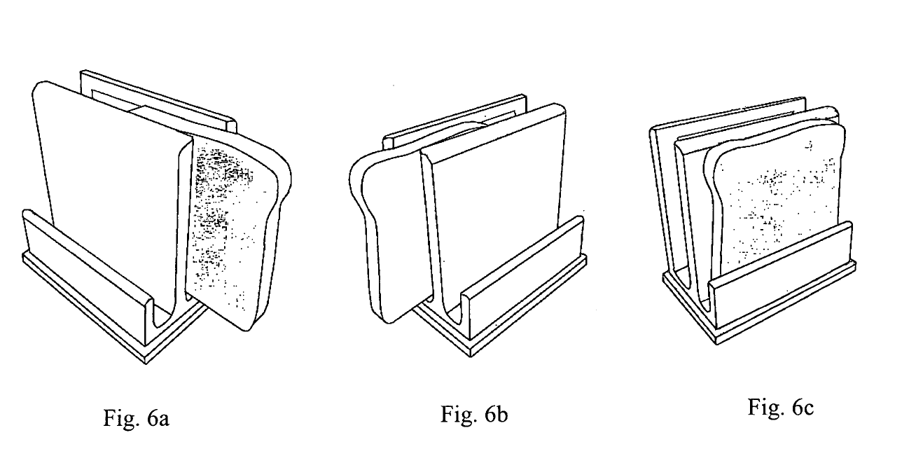

In yet another embodiment shown in FIGS. 6a to 6c, the oven has only one receptacle space on its one side, instead of two channels as in the embodiment shown in FIG. 5. All the other internal components, structures, and the oven's working principle, are similar to the embodiment described above.

The embodiments of the present invention are thus fully described. Although the description referred to particular embodiments, it will be clear to one skilled in the art that above embodiments can be practiced with variation of these specific details. Hence this invention should not be construed as limited to the embodiments set forth herein.

For example, although the moving speed of the toaster is described as constant in the previously described embodiments, it could be set variable by for example adding control circuit for the motor. Changing the moving speed of the bread is another way of adjusting the dryness of the toast, which would yield substantially the result as adjusting the power (temperature) of the heater. Moreover, changing the moving speed of the bread would also achieve other effects such as obtaining different dryness for different part of the toast. For example, if the user wants half of the toast to be less dry and the other half to be more dry, he or she can adjust the moving speed during toasting, so that the first half of the toast will have a shorter exposure time while the second half of the toast has a longer exposure time.

In the description the hot plates used to conduct heat from the heating elements to the bread are made of alumina. In other embodiments, the heating elements are formed of other materials, such as copper or silver.

The height of heater is preferably equal or larger than that of a piece of bread 36 as described previously. However, one should realize that other types of heater and/or its configuration could also be utilized for the same purpose of heating. For example, the heater can be in a helix form or it can be fixed with a certain angle not necessarily 90 degrees from the base.

In a specific embodiment described previously, the oven uses a cog driving system to transport the bread between the inlet opening and the outlet opening. In other embodiments, a compact and reliable transport mechanism would also suffice to transport the bread.

What is claimed is:

1. An oven comprising:
a housing including a base and two opposing side walls defining an interspace therebetween;
an inlet opening vertically disposed on one side of said interspace;
at least one heating element disposed on an inner surface of said side walls facing said interspace; and
a transfer mechanism provided within said housing for transporting a food product across said interspace from said inlet opening;
wherein said food product introduced into said oven is supported by said base, is transported across said interspace with said transfer mechanism, and is uniformly heated across both sides of the food product by said heating element.

2. The oven according to claim 1, further comprising a outlet opening disposed within said interspace opposite said inlet; wherein said food product is transported across said interspace from said inlet opening to said outlet opening while the food product remains in an upright vertical position.

3. The oven according to claim 2, wherein more than one said food products are introduced to said interspace one by one.

4. The oven according to claim 1, wherein said oven is a toaster; said food product is a piece of toast; the width and height of said interspace receives and supports the piece of toast with one side of said piece of toast resting on said base as the piece of toast is transported through the interspace.

5. The oven according to claim 1, wherein a length of said base is longer than a length of each said side wall such that two distal ends of the base extend from said side wall.

6. The oven according to claim 1 wherein a width of said interspace ranges from 1.2 cm to 3 cm, and a height of said interspace ranges from 10 cm to 20 cm.

7. The oven according to claim 1, wherein a length of each of said side walls is shorter than a length of said food product.

8. The oven according to claim 1, wherein said base further comprises an elongated upper surface with a channel provided along at least a section of a longitudinal axis of an upper surface for supporting said food product in a vertical position.

9. The oven according to claim 1 further comprising horizontally aligned transport elements, transport axes connected vertically to each of said transport elements, and drive cogs disposed vertically within said interspace and opposite to each said transport axis; wherein once being introduced into said oven, said food product is inserted between said transport axes and said drive cog such that movement of said transport axes drives transportation of said food product across said interspace between said inlet and outlet openings.

10. The oven according to claim 8, wherein said transport axis is disposed adjacent to said inlet.

11. The oven according to claim 8, wherein said transport elements and said transport axes are disposed on one side of said interspace along the longitudinal axis thereof.

12. The oven according to claim 8 further comprising a belt rotating about said transport elements.

13. The oven according to claim 8 further comprising springs provided between said transport axes and said side wall such that a distance between each of said transport axes and the drive cog is adjustable due to compression of said springs.

14. A method of toasting a piece of bread having two faces and four sides, said method comprising:
providing said piece of bread in a vertical position with at least one face of said piece of bread being adjacent to a vertically disposed heating element, said heating element being provided along a height of said piece of bread;
transferring said piece of bread in a horizontal direction along a longitudinal axis of said piece of bread with one side of the piece of bread resting on a base to expose a entire surface of two faces to said heating element using a transfer mechanism;
uniformly heating opposite sides of said piece of bread; and
transferring said piece of bread against said heating element such that said piece of bread is being heated continuously in a direction against a moving direction of said piece of bread.

15. The method according to claim 13, wherein said piece of bread is driven in said horizontal direction by at least one transport axis, said transport axis being motivated by a transport element connected thereto; a drive cog being disposed vertically opposite to said transport axis.

16. An oven comprising:
a housing including a base and two opposing side walls defining an interspace therebetween;
an inlet opening vertically disposed on one side of said interspace;
at least one heating element disposed on an inner surface of said side walls facing said interspace; and
a transfer mechanism provided within said housing for transporting a food product across said interspace from said inlet opening;
wherein the length of said side walls is shorter than the length of said food product;
said food product introduced into said oven is supported by said base, is transported across said interspace with said transfer mechanism, and is uniformly heated across both sides of the food product by said heating element.

17. The oven according to claim 16, further comprising a outlet opening disposed within said interspace opposite said inlet; wherein said food product is transported across said interspace from said inlet opening to said outlet opening while the food product remains in an upright vertical position.

18. The oven according to claim 17, wherein more than one said food products are introduced to said interspace one by one.

19. The oven according to claim 16, wherein said oven is a toaster; said food product is a piece of toast; the width and height of said interspace receives and supports the piece of toast with one side of said piece of toast resting on said base as the piece of toast is transported through the interspace.

20. The oven according to claim 16, wherein a length of said base is longer than a length of each said side wall such that two distal ends of the base extend from said side wall.

21. The oven according to claim 16, wherein a width of said interspace ranges from 1.2 cm to 3 cm, and a height of said interspace ranges from 10 cm to 20 cm.
